(19) United States
(12) Patent Application Publication
(10) Pub. No.: US 2016/0350746 A1
(43) Pub. Date: Dec. 1, 2016

(54) CONSUMER FRIENDLY TOKEN NUMBER ALLOCATION

(71) Applicant: MasterCard International Incorporated, Purchase, NY (US)

(72) Inventor: Alan Johnson, Essex (GB)

(21) Appl. No.: 15/150,671

(22) Filed: May 10, 2016

Related U.S. Application Data
(60) Provisional application No. 62/167,491, filed on May 28, 2015.

(51) Int. Cl. G06Q 20/36; H04L 29/08

(52) U.S. Cl. CPC G06Q 20/3672; H04L 67/10

(57) ABSTRACT

A consumer-friendly token number allocation method and system. In an embodiment, a token service provider (TSP) computer receives a tokenization request from a token requestor that includes a primary account number (PAN) of a cardholder. The TSP computer then allocates a token prefix number to a Token Number, sets the least significant four digits of the Token Number to the last four digits of the PAN, generates middle digits of the Token Number such that the complete Token Number satisfies a checksum, and stores the Token Number in association with the PAN. In an implementation, the TSP computer also transmits the Token Number to the cardholders' proximity payment device for use to conduct one or more purchase transactions.

### FIELD OF THE INVENTION

The present disclosure generally relates to systems, apparatus and methods for generating and/or providing tokens to consumers for use in transactions. In particular, disclosed embodiments provide systems and methods for providing one or more unique Token Numbers to a consumer, wherein the last four digits of the allocated Token Number match the last four digits of the consumer's Primary Account Number (PAN).

### BACKGROUND

Wireless or proximity payment devices, such as chip cards and/or payment enabled mobile devices, are becoming increasingly popular. Such proximity payment devices typically include a secure microprocessor and data storage device or chipset (also referred to as a radio frequency identification or “RFID” chip), and an antenna. Both the RFID chip and the antenna may be embedded in the body of the proximity payment device, which may have the same shape and dimensions as a conventional payment card such as a credit card or a debit card. However, proximity payment devices may also take the shape of another type of form factor, such as a fob, key ring, wristband, or the like. In order to support the use of such devices for consumer payment transactions, proximity payment systems such as the “PayPass®” system have been developed (which is operated by MasterCard International Incorporated, the assignee hereof). MasterCard® issuer financial institutions (FIs), which are entities (such as banks) that issue consumer payment card accounts, have the option of issuing PayPass® payment devices to their cardholders.

Some proximity payment device embodiments consist of an RFID chip (or payment chipset) and antenna embedded within a consumer's mobile device, such as a Smartphone, tablet computer, digital music player, and/or personal digital assistant (PDA). The RFID chip may store a payment card account number to be wirelessly transmitted from the proximity payment device (via the antenna) when the payment device is presented for proximity coupling to a reader device associated with a retailer's point-of-sale (POS) terminal. In one approach, near field communication (NFC) technology is used to securely transmit the payment credentials from the consumer's mobile device to an NFC reader device associated with a merchant's POS terminal. In such cases, a secure element (SE) chip included as part of the consumer's mobile device can be utilized.

Payment systems that accept proximity payment devices provide measures to ensure that the consumer's Primary Account Numbers (PANs) of their payment card accounts are protected from being stolen by wrongdoers, and an important initiative to prevent any such unauthorized access to PANs involves using “tokenization.” Tokens may be defined as surrogate values that replace PANs in part of a payment system. Thus, according to one use case set forth in the Payment Token Interoperability Standard (issued by payment card processors MasterCard International Incorporated, Visa and American Express in November 2013), a mobile device with NFC capabilities can be “tokenized” or provisioned with a token. Tokens are typically provisioned by a Token Service Provider, and each token is composed of a Token Number that is associated with the consumer's PAN. Thus, a consumer may then use his or her mobile device to wirelessly pass the token and payment information via NFC to the merchant's POS terminal during a purchase transaction. A payment authorization request is then originated from the POS terminal and routed via an acquiring financial institution to the Token Service Provider. The authorization request includes the token and other information (but not the PAN), and may also include an indication that the transaction was initiated via an NFC read at the POS terminal.

The Token Service Provider (TSP) maintains a secure database (or “vault”) that is used to map tokens to associated PANs. In the above example, the TSP may recognize that the token in the purchase authorization request is authorized for use for NFC transactions at point of sale devices, and then replaces the token with the corresponding PAN (which the token represents). The TSP next routes the purchase authorization request (which now includes the PAN and other information such as the transaction amount) to the issuer of the payment card account identified by the PAN. In addition, in some transaction implementations the microprocessor of the consumer's proximity payment device generates a unique dynamic cryptogram using the transaction data and a cryptographic key that was provisioned to the proximity payment device during a personalization process and that was stored in a secure memory. This unique dynamic cryptogram generated by the proximity payment device is also transmitted to the card issuer with the purchase transaction data for transaction authorization processing. The card issuer uses its keys and codes to calculate a cryptogram based on the same transaction data. If the dynamic cryptogram received from the consumer's proximity payment device matches the issuer's calculated cryptogram, the issuer then knows that the transaction data was received from a valid proximity payment device and proceeds with authorization processing. Therefore, due to such security measures (tokenization and the use of dynamic cryptograms), transactions conducted with proximity payment devices, such as payment-enabled mobile devices, are generally more secure than transactions conducted with conventional magnetic stripe credit cards and/or debit cards.

The Token Number allocated as the token for any particular consumer's proximity payment device typically is not of any particular interest to the cardholder because it is simply a substitute for the original PAN. However, there are circumstances where the use of a “number” that is different from the cardholder's PAN may cause service issues for that cardholder. In particular, the “last four (4) digits” of the PAN are usually printed on the merchant's receipt of a purchase transaction and may also be identified within (and utilized by) a merchant's transaction system, especially for online merchants that store “card on file” information for e-commerce transactions with their customers. Conventionally, the last four digits of a token do not match the last four digits of the PAN. Thus, when a payment account holder requires a refund, for example, and the original token cannot be used in the refund transaction (for example, the original consumer device containing the token is unavailable to the cardholder, or the refund is being processed remotely), a problem arises because the merchant typically will attempt to process a refund to the original payment card account, which may now be impossible to identify when the token number does not match the Primary Account Number (PAN) (and/or when the last 4 digits of the token do not match the last 4 digits of the PAN). In such cases, the merchant may only be able to offer a store credit, which the consumer (payment account holder) may not desire.

Accordingly, there is a need for a technical solution for generating and/or providing a Token Number for use in transactions in such manner to ensure that the last four digits of the Token Number always match the last four digits of the consumer's Primary Account Number (PAN) to eliminate problems that may occur post transaction.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 depicts an example of a proximity payment card of a type that may be tokenized according to embodiments of the methods and systems described herein;

FIG. 2 is a block diagram of a system configured for allocating Token Numbers to proximity payment devices and for conducting purchase transactions by using tokens according to embodiments of the disclosure; and

FIG. 3 is a flowchart illustrating a tokenization process that provides unique Token Numbers in accordance with the systems and methods described herein.

### DETAILED DESCRIPTION

In general, and for the purpose of introducing concepts of embodiments of the present disclosure, systems and methods are disclosed for generating and/or providing tokens for use in transactions. In particular, disclosed embodiments provide Token Numbers for use in purchase transactions, wherein the last four digits of an allocated Token Number match the last four digits of the Primary Account Number (PAN) of a cardholder's or consumer's payment account.

A number of terms are used herein. For example, the term “tokenize” and/or “tokenization” as used herein refers to providing a token or Token Number that is associated with a consumer's primary account number (PAN) by a token service provider (TSP) in accordance with novel disclosed aspects. In addition, the term “payment card network” or “payment network” as used herein refers to a payment network or payment card network or payment system operated by a payment processing entity, such as MasterCard International Incorporated, or other networks which process payment transactions on behalf of a number of merchants, issuers and payment account holders (such as credit card account and/or debit card account and/or loyalty card account holders, commonly referred to as cardholders or payment account holders). Moreover, the terms “payment card network data” or “network transaction data” or “payment network transaction data” refer to transaction data associated with payment or purchase transactions that have been or are being processed over a payment network. For example, network transaction data may include a number of data records associated with individual payment transactions (or purchase transactions) of consumers or cardholders that have been processed or are being processed over a payment card network. In some embodiments, network transaction data may include information that identifies a cardholder, a payment device and/or payment account (such as a credit card or debit card account), a transaction date and time, a transaction amount, items and/or services that have been purchased, and information identifying a merchant and/or a merchant category. Additional transaction details may also be available in some embodiments.

Examples of tokenization embodiments are illustrated in the drawings and accompanying text, and it should be understood that the drawings and descriptions thereof are not intended to limit the invention to any particular embodiment(s). On the contrary, the descriptions provided herein are intended to cover alternatives, modifications, and equivalents thereof. Thus, although numerous specific details are set forth in order to provide a thorough understanding of the various embodiments, some or all of these embodiments may be practiced without some or all of the specific details. In other instances, well-known process operations have not been described in detail in order not to unnecessarily obscure novel aspects.

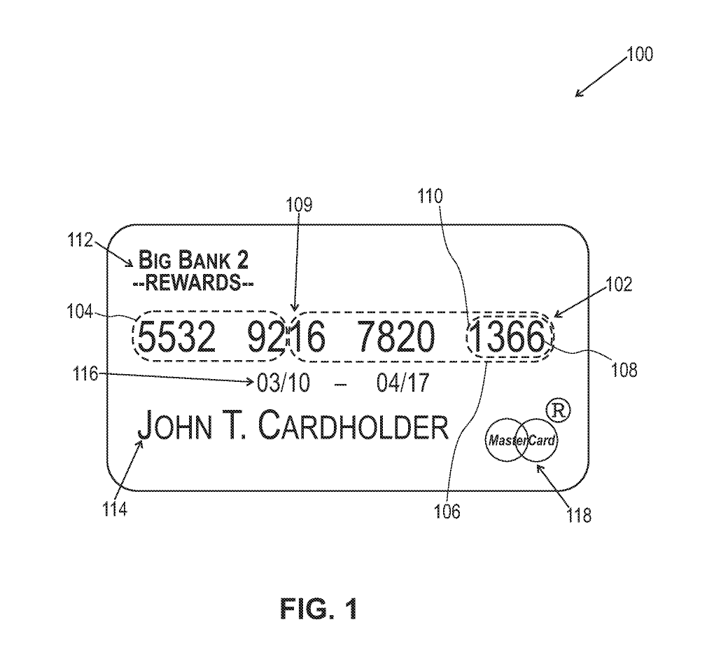

FIG. 1 depicts an example of a proximity payment card 100 (also known as a “chip card” or “smart card”) of a type that may be tokenized according to embodiments of the methods and systems described herein. Such proximity payment cards or devices typically include a secure microprocessor and data storage device or chipset (such as an RFID chip) and an antenna (not shown), and may also have the shape of another type of form factor, such as a fob, key ring, wristband, armband, or the like. In addition, some proximity payment device embodiments consist of an RFID chip (or payment chipset) and antenna embedded within a consumer's mobile device, such as a Smartphone, smart watch (or any other type of “wearable” electronic device), tablet computer, digital music player, and/or personal digital assistant (PDA) and the like. In particular, manufacturers are increasingly equipping Smartphones with hardware and/or middleware and/or software configured to facilitate wireless payments for purchase transactions so that consumers can go shopping and then utilize such consumer mobile devices to pay for products and/or services. For example, an RFID chip embedded in a Smartphone may store payment card account information and other data that is transmitted (via the antenna) when, for example, the consumer presents his or her Smartphone (as a proximity payment device) for proximity coupling to a reader device associated with a merchant's (or retailer's) point-of-sale (POS) terminal. Near field communication (NFC) technology or other types of wireless technology (such as Bluetooth™) may be used to securely transmit such payment credentials from the consumer's mobile device (for example, a Smartphone) to a reader device which may be associated with a merchant's POS terminal. In such cases, a secure element chip (not shown) included as part of the consumer's mobile device can be utilized to conduct the purchase transaction.

Referring again to FIG. 1, the example proximity payment card includes a sixteen (16) digit Primary Account Number (PAN) 102 which may be printed and/or embossed on a front face of the card. In the case of a consumer mobile device, the PAN 102 is typically not printed on the device and is otherwise not displayed during a purchase transaction. In some implementations, the PAN is a sixteen to nineteen (19) digit number, and in some embodiments this is the number that is tokenized in accordance with methods described herein. As depicted in FIG. 1, it is common to have additional identifying features present and/or shown on the face of the proximity payment card 100, such as a an issuer bank's name 112, the cardholder's name 114, an expiration date 116, and a payment card processor's insignia 118 (which typically is a registered trademark). However, one or more of such identifying features may not be included on the front face of the card in some implementations, and such identifying features are typically not displayed on the surface or face of a consumer mobile device (such as a Smartphone) that is configured to conduct purchase transactions.

In the example payment card shown in FIG. 1, the first six (6) digits 104 of the PAN typically identify the issuer financial institution (FI) of the payment card account (for example, an issuer bank). The next ten digits 106 of the PAN may be used to identify the cardholder's account, wherein the final digit 108 (which is six (“6”) in the example depicted in FIG. 1) is typically a check digit. In some implementations, the check digit may be calculated, for example, using the “LUHN” algorithm (also known as the “modulus 10” or “mod 10” algorithm), but it should be understood that other types of checksum algorithms can be used as well. The LUHN algorithm is a well-known and simple checksum formula used to validate identification numbers (such as the PAN of a payment card or a Token Number), which is used to protect against accidental errors. For example, the LUHN algorithm may be utilized to distinguish valid numbers, such as a payment card PAN, from mistyped numbers or misread numbers or otherwise incorrectly input numbers (which may occur from time to time, for example, due to human input error and/or due to a communications error when a reader device is in the process of reading a number from a proximity device).

With regard to FIG. 1, some issuer FIs and/or other entities may utilize the seventh digit 109 (which is a “1” in the illustrated example) or a number of additional digits to differentiate between financial products, such as between a credit card account and a debit card account. In the example shown in FIG. 1, the first seven digits are utilized to identify the issuer and payment product. Thus, when allocating a Token Number (i.e., performing tokenization) a determination must be made as to what type of payment product the PAN represents to ensure that the Token Number that is allocated will match the payment product associated with that PAN. This is important to ensure that, for example, when the tokenized proximity payment card is used in a purchase transaction it is correctly identified so that the merchant is charged the correct fee and/or the issuer FI receives the correct Interchange fee(s), as well as for other reasons, such as post-processing concerns. In some embodiments, as mentioned above, additional digits may be utilized to differentiate between financial products and such additional digits may also be utilized, for example, by an issuer FI to indicate a subsidiary company or a branch of their business to which the cardholder is associated.

Furthermore, in novel embodiments described herein, a Token Number is allocated to a proximity payment device such that the last four (4) digits of the Token Number match the last four digits 110 (including the final check digit 108) of the cardholder's PAN. This is important to facilitate merchant post-processing needs which may occur, for example, to process a payment card account holder request for a refund, or to process merchandise returns, and/or for record management purposes. In particular, the last four digits of the cardholder's PAN are typically required by a merchant to identify the cardholder's payment account so that a return or exchange of merchandise can be processed such that the cardholder's payment account can be credited and/or charged-back.

It should be understood that the length (number of digits) of an Issuer identifier within a Token Number may vary, which length may be specific to each particular Issuer financial institution (FI) and the type of payment account product that the PAN represents (examples of payment card products include, but are not limited to, credit cards, debit cards, merchant loyalty cards, public transit cards, and gift cards). However, in some other embodiments, the length of the Issuer identifier within the Token Number is specific to a Token Vault associated with a Token Services Provider (TSP) and the type of payment account product that the PAN represents. Moreover, in order to maximize the number of Token Numbers that can be allocated, a Token Vault can utilize a different six digit Issuer identifier for each type of payment account product. In addition, in some embodiments, the allocated Token Number is a maximum of nineteen (19) digits long in order to maximize the number of possible Token Numbers available as many Tokens may be allocated for an individual PAN. For example, a payment card account holder may request tokenization for his or her mobile telephone or Smartphone, another tokenization for his or her iPad, and yet another tokenization for a personal digital assistant (PDA) so that three unique Token Numbers are allocated but each one is associated with the same PAN. Thus, in this case the consumer or cardholder can then utilize any of his or her devices (Smartphone, iPad or PDA) to conduct a purchase transaction (utilizing one of the three unique Token Numbers) for goods or services which will be charged to his or her payment card account.

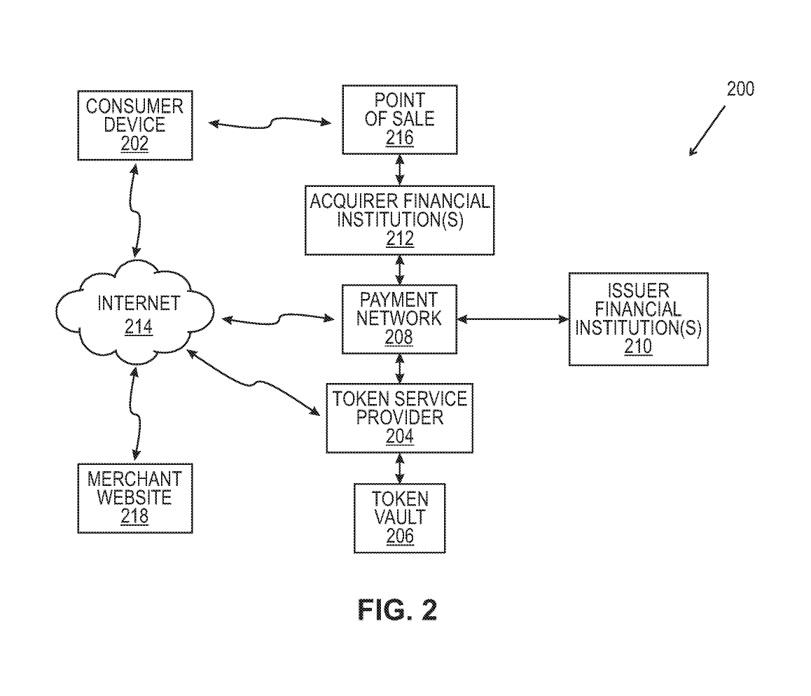

FIG. 2 is a block diagram of a system 200 configured for allocating Token Numbers to proximity payment devices, such as the consumer device 202, and for conducting purchase transactions by using tokens issued to payment account holders. It should be understood that the various blocks or components shown in FIG. 2 may be a subset of a larger system for providing tokens and/or transaction processing to consumers who are payment card account holders. It should also be understood that the consumer device 202 may be any type of mobile computing device suitable for performing the functions as disclosed herein, and includes, but is not limited to, a cellular phone, a Smartphone, a smart watch (or other “wearable” electronic device), a tablet computer, a digital music player, a key fob, a proximity payment card (such as a smart card or chip card), and the like. In some embodiments, the consumer mobile device 202 includes a secure element (not shown) that is tamper-resistant and configured for securely storing data. Such a secure element may be a hardware chip or chipset. For example, the secure element may be a chipset including a secure memory element storing one or more cryptographic keys that may have been provisioned to the secure element at the time of the manufacture of the mobile device 202, or via an over-the-air (OTA) provisioning method (not described herein). However, in some implementations the token issued to a payment account holder may be stored elsewhere, such as on a server computer and/or by a cloud computing system, and in such cases the consumer's device 202 is operable to access that token during a transaction.

The system 200 of FIG. 2 includes a Token Service Provider computer 204 that is operably connected to a token vault 206 (which may be a storage device and/or database) and to a payment network 208. Token Service Providers (TSPs) are entities that are authorized to generate and provide Tokens to registered token requestors and in some embodiments may be owned and/or operated by the operator of the payment network 208. Token Service Providers are responsible for a number of functions including, but are not limited to ongoing operation and maintenance of the Token Vault 206, Token Number generation and issuance, application of security and controls, payment token provisioning and token requestor registry functions. In some embodiments, the Token Service Provider 204 builds and manages its own proprietary token requestor application programming interfaces (APIs), Token Vaults, token provisioning platforms, and token registries. The individual functional requirements that comprise such platforms and related systems are not described in detail herein, however, the TSP 204 ensures that the Token Numbers (or token Bank Identification Number (BIN) ranges) are managed distinctly from traditional bank identification numbers BINs (or BIN ranges), in part to avoid any inadvertent overlap of PANs and payment Token Numbers.

Referring again to FIG. 2, the payment network may be operably connected to a plurality of issuer financial institutions (FIs) 210, to a plurality of acquirer FIs 212, and to the Internet. The acquirer FI 212 may be operably connected to one or more point of sale (POS) terminals 216 associated with a merchant. Thus, although only one mobile consumer device 202, one POS terminal 216, one acquirer FI 212, one issuer FI 210, and one merchant website 218 are shown in FIG. 2, it should be understood that in practice the system 200 may include a large number of such components or devices. In particular, for ease of understanding the drawing only shows components that are active in connection with a single transaction out of a large number of transactions that may be handled by the payment network 208 on an ongoing basis.

As shown in FIG. 2, the merchant website 218 may be operably connected to the Internet 214, and may be configured for communications with, for example, consumer devices 202, the Token Service Provider 204, and the payment network 208. It should be understood that the various blocks or components of the system 200 might be associated with, for example, a computer network or computer system that includes one or more computers, an enterprise server, a server farm, and/or one or more databases or similar storage devices. The databases and/or storage devices may be non-transitory computer-readable storage media that may store thereon instructions that when executed by a machine (such as a processor or computer) or electronic device results in performance according to any of the embodiments described herein. It should also be noted that some or all of the process steps may be “automated,” which refers to, for example, actions that can be performed with little or no human intervention. In addition, it should be noted that the payment network 208, Token Service Provider 204 and/or the Token Vault 206 may, according to some embodiments, be owned and/or operated by and/or associated with a payment card processing company, such as MasterCard International Incorporated.

In some implementations, the TSP 204 provides a standard method for use by a registered token requestor, which may be a merchant or acquirer FI or mobile device original equipment manufacturer (“OEM,” such as Apple Inc., manufacturer of the iPhone line of smartphones) to submit a request through a standard interface (not shown) to input original payment credentials and receive a Token Number in response. The TSP 204 also implements appropriate controls and processes to generate a Token Number based on the input PAN, and may perform assurance steps on the request. The token request interface may support real-time requests that require issuance of a payment token for each PAN requested, or in-bulk requests through a secure interface file where Token Numbers are generated and issued in bulk quantities for one or more entities (for example, to an issuer FI for one or more particular BIN ranges) and returned to the token requestor. A generated token may then be stored in the Token Vault 206 for use in payment transactions, and/or may be transmitted to a consumer device 202 (i.e., to an NFC-enabled Smartphone), for example, via the Internet 214 (or wirelessly via a wireless communications provider (not shown)) from the TSP 204 and stored within the consumer device 202. As mentioned earlier, in some embodiments the generated token may be stored in a cloud computing system or some other type of network storage device, and then accessed by the consumer device for use during a transaction. Alternately, the TSP 204 may deliver a Token Number to the consumer device 202 at the time of a transaction.

Thus, token provisioning (or tokenization) can be accomplished by the token requestor interfacing with the TSP 204. When a transaction is initiated, the consumer device 202 and/or the TSP 204 will generate a contactless transaction including the token, a token expiration date, a token cryptogram, and/or other chip data elements, and pass the transaction to the merchant's POS terminal 216 via the NFC interface. Thus, the consumer mobile device 202 interacts with the NFC reader (not shown) of the POS terminal 216 through a payment application and passes a payment Token Number (as the PAN), a token expiration date, a token cryptogram (generated based on the token data elements), a token requestor identifier, and/or other contactless data elements. Next, the merchant's POS terminal 216 passes the contactless authorization request to the acquirer FI 212, which performs processing checks and passes the token data fields and the contactless data to the payment network 208. The payment network then communicates with the TSP 204 to retrieve the PAN, verify the state of the Token Number to PAN mapping in the Token Vault 206 for the active token, and other controls and/or criteria that may be defined for that token. The payment network 208 also validates the token cryptogram and validates any token domain restriction controls for that payment token (or alternatively, the payment account issuer FI 210 may validate the cryptogram if it has the necessary keys), and retrieves the token requestor identifier if it was not provided in the authorization message. Next, the payment network 208 generates an authorization request message for transmission to the issuer FI 210. The payment network forms the authorization request message by replacing the payment token with the PAN, replacing the token expiration date with the PAN expiration date, adds an indicator that conveys to the payment account issuer FI that an on-behalf-of validation has been completed by the TSP 204 of that payment token (i.e., the Token Number is valid). The issuer FI 210 receives the authorization request message and then completes account-level validation and the authorization check, and sends the PAN back in an authorization response to the payment network 208. The payment network 208 (in some embodiments, in communication with the TSP 204) may generate a response cryptogram and will replace the PAN with the payment token based on the mapping. The payment network also transmits the following required fields to the acquirer FI 212 as part of the authorization response, in addition to other data elements, such as the payment token, a token assurance level, the last four digits of the PAN, and a PAN product identifier (which may be optional). The acquirer FI then transmits the authorization response to the merchant's POS terminal 202, and the consumer is notified of the success or failure of the purchase transaction.

In an electronic commerce (or E-commerce) scenario, a payment card account holder can initiate payment to an E-commerce site or merchant website 218 using a mobile wallet (or digital wallet) to transfer payment and other order information. Such mobile wallets may be operated by payment account issuers FIs 210, the payment network 208, and/or third parties, and in many embodiments the digital wallet operator will likely be the token requestor. In this use case, the wallet operator uses tokenization to avoid the need to store the cardholder's PAN in the wallet platform for security or other business reasons. Thereafter, when a payment account holder initiates payment at a merchant website 218 that supports the electronic wallet, the electronic wallet will pass a payment token (instead of the PAN) along with additional payment token-related fields through a mobile wallet application programming interface (API) to the merchant website. Merchants will initiate authorizations using the payment Token Number and accompanying token expiration date in the same manner described above. In some embodiments, the merchant may store the unique Token Numbers of customers so that processing can occur using “card-on-file” processing without the need to store each customer's PAN. In addition, the stored tokens may be designated as only being recognized for purchase transactions involving that merchant's website.

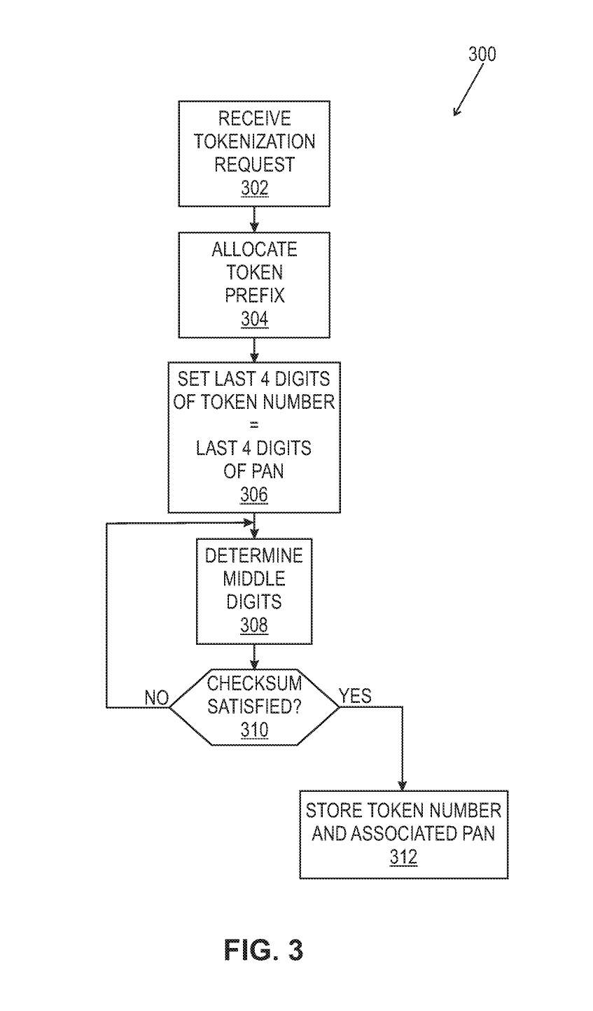

FIG. 3 is a flowchart illustrating a tokenization process 300 that provides a unique Token Number with the last 4 digits equal to the last 4 digits of a cardholder's PAN in accordance with the systems and methods described herein. In particular, a TSP receives 302 a token request from a requester, which token request includes the primary account number (PAN) of a payment card account holder or consumer or cardholder. As mentioned above, the token requester may be an entity such as an issuer FI or merchant or cardholder. Next, the TSP then begins the tokenization process by allocating 304 a token prefix number (which is either an issuer-defined value or a Token Vault defined value) that is at least six (6) digits in length and comprises the most significant digits of the Token Number. In some embodiments, the token prefix number includes a payment product type identifier (for example, one or more digits that identify the payment product as being a credit card account, loyalty card account, or debit card account). Next, the TSP sets 306 the least significant four (4) digits of the Token Number to match the last four (4) digits of the PAN. The TSP then determines 308 the middle digits or middle portion of the Token Number, which may consist of six (6) digits up to nine (9) digits.

In particular, the middle digits if a Token Number are determined such that the completed or full Token Number (which may be up to nineteen (19) digits long) is unique (i.e, there is no other Token Number currently in circulation that is the same), and so that it satisfies a Checksum or check digit algorithm, such as the LUHN formula. The actual method or process for determining the middle digits may vary. For example, the process for determining the middle digits of the Token Number may include incrementing the last Token Number used, or may include randomly selecting a six to nine digit number for each Tokenization that has not already been allocated. (It should be understood that the actual Token Number that is determined is not in and of itself significant because that Token Number will not be used by the cardholder or the issuer FI within any wider numbering scheme.) Thus, the TSP determines 310 if the Checksum (such as the LUHN formula) is satisfied, and if not the process branches back to step 308 wherein the middle digits are again determined. But once the Checksum is satisfied, the Token Number is stored 312 in the Token Vault along with the associated PAN. The token is also transmitted to the cardholder's proximity payment device where the Token Number may be stored and utilized for purchase transactions. Thus, when the cardholder utilizes his or her proximity payment device for a purchase transaction, the allocated Token Number can then be used to map transactions that occur using the token to the PAN of that cardholder. In some embodiments, one or more tokens may have very short life-spans, which may range from the duration of one transaction to many transactions over the multi-year life of a proximity payment card account. For example, a Token Number may be allocated for use in only one transaction so that when a purchase transaction is consummated then that Token Number is de-allocated. In other cases, a Token Number may be de-allocated after a predetermined amount of transactions have occurred, for example, after an cardholder has used the Token Number for ten transactions (the actual number of transactions for which a particular Token Number is valid may be set by, for example, an issuer FI or a merchant or some other entity in accordance with business rules and/or other criteria). In yet other cases, a Token number may be de-allocated after a predetermined amount of time has expired, such as one week or six months or one year after first use of the Token Number (again, the threshold time value after which de-allocation occurs may be set by a third party or entity associated with the cardholder and/or with the cardholder's payment account). Once a particular Token Number is de-allocated, that Token Number may be re-used in a subsequent tokenization process to allow a complete set of Token Numbers to be recycled over time. Thus, cardholders and/or

An advantage provided by many or all of the embodiments described herein is that the disclosed tokenization processes require no modification of the TSP or transaction processing systems currently installed and in use by payment networks, issuer FIs, acquirer Fis, and merchants. In particular, merchants can utilize their current systems and methods for conducting post processing functions that are based on the last 4 digits of a cardholder's PAN for purchase transactions that were consummated utilizing a token. This is possible because the apparatus and methods disclosed herein provides a token to a cardholder's proximity payment device having a Token Number with the last 4 digits the same as the last 4 digits of the cardholder's PAN. In order to accomplish this, a token service provider (TSP) generates the token for use in transactions in accordance with the disclosed processes. Thus, when the consumer or cardholder then needs to request a refund, or when the merchant must conduct one or more other types of post-transaction processing functions, such functions can be accomplished by utilizing the last 4 digits of the Token Number assigned to the token because they match the last 4 digits of the PAN. In addition, printed merchant receipts conventionally include and/or show the number captured by the payment terminal (such as by a merchant's POS), and thus the last 4 digits on the printed receipt will now match the last 4 digits of the customer's PAN meaning that cardholders will be able to tell and/or confirm which tokenized payment card (or payment device) was used for that transaction, which minimizes any impact of tokenization for consumers. For example, in the event that a cardholder wishes to return and/or exchange a purchased item then he or she can discern which tokenized payment account was utilized for the transaction for presentation to the merchant if required.

Any flow charts and descriptions thereof herein should not be understood to prescribe a fixed order of performing the method steps described therein. Rather, the method steps may be performed in any order that is practicable, including combining one or more steps into a combined step.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A token number allocation method comprising:
receiving, by a token service provider (TSP) computer from a token requestor, a tokenization request comprising the primary account number (PAN) of a cardholder;
allocating, by the TSP computer, a token prefix number to a Token Number;
setting, by the TSP computer, the least significant four digits of the Token Number to the last four digits of the PAN;
generating, by the TSP computer, middle digits of the Token Number such that the complete Token Number comprising the token prefix number, the middle digits, and least significant four digits satisfies a checksum; and
storing, by the TSP computer, the Token Number in association with the PAN.

2. The method of claim 1, further comprising transmitting, by the TSP computer, the Token Number to a proximity payment device of a cardholder for use in conducting at least one purchase transaction.

3. The method of claim 1, further comprising transmitting, by the TSP computer, the Token Number to a merchant computer for storage in order to conduct “card-on-file” processing for a cardholder.

4. The method of claim 1, wherein the token requester comprises one of a consumer, a merchant, and an issuer financial institution (FI).

5. The method of claim 1, wherein storing comprises storing the Token Number in association with the PAN in a token vault.

6. The method of claim 1, wherein storing comprises transmitting, by the TSP computer, the Token Number and associated PAN to at least one of a merchant computer and a cloud computing system for storage.

7. The method of claim 1, wherein generating, by the TSP computer, the middle digits of the Token Number comprises one of incrementing the last Token Number used or randomly selecting a six to nine digit number and ensuring that the ransom six to nine digit number has not already been allocated.

8. The method of claim 1, further comprising de-allocating the Token Number when at least one of a purchase transaction is consummated, after a predetermined amount of purchase transactions have occurred, and after a predetermined amount of time has expired.

9. The method of claim 1, wherein the checksum that is satisfied comprises the LUHN algorithm.

10. The method of claim 1, wherein the token prefix number comprises at least six digits and includes a payment product type identifier.

11. The method of claim 10, wherein the payment account product comprises one of a credit card, a debit card, a merchant loyalty card, a public transit card, and a gift cards.

12. The method of claim 1, wherein the token prefix number includes an Issuer identifier.

13. The method of claim 12, wherein the length of the Issuer identifier within the Token Number is specific to a Token Vault associated with a Token Services Provider (TSP) and the type of payment account product that the PAN represents.

14. The method of claim 13, wherein the Token Vault utilizes a different Issuer identifier for each type of payment account product in order to maximize the number of Token Numbers that can be allocated.

15. The method of claim 1, wherein the allocated Token Number is a maximum of nineteen (19) digits long to maximize the number of possible Token Numbers available.

16. A token number allocation system comprising:
a token service provider (TSP) computer;
a payment network operably connected to the TSP computer;
at least one consumer device operably connected to the TSP computer;
wherein the TSP computer comprises a storage device including instructions configured to cause the TSP computer to:
receive from one of the merchant computer, the issuer FI and the consumer device, a tokenization request comprising the primary account number (PAN) of a cardholder;
allocate a token prefix number to a Token Number;
set the least significant four digits of the Token Number to the last four digits of the PAN;
generate middle digits of the Token Number such that the complete Token Number comprising the token prefix number, the middle digits, and least significant four digits satisfies a checksum; and
store the Token Number in association with the PAN.

17. The system of claim 16, further comprising a token vault operably connected to the TSP computer, and wherein the storage device further comprises instructions configured to cause the TSP computer to store the Token Number in association with the PAN in the token vault.

18. The system of claim 16, wherein the storage device further comprises instructions configured to cause the TSP computer to transmit the Token Number to a proximity payment device of a cardholder for use in conducting at least one purchase transaction.

19. The system of claim 16, wherein the storage device further comprises instructions configured to cause the TSP computer to transmit the Token Number to a merchant computer for storage in order to conduct “card-on-file” processing for a cardholder.
